(19) United States
(12) Patent Application Publication
(10) Pub. No.: US 2019/0106277 A1
(43) Pub. Date: Apr. 11, 2019

(54) GARBAGE CAN

(71) Applicant: Christian Reyes, Paterson, NJ (US)

(72) Inventor: Christian Reyes, Paterson, NJ (US)

(21) Appl. No.: 15/728,494

(22) Filed: Oct. 9, 2017

(51) Int. Cl. B65F 1/14; A47L 13/51; B65F 1/16

(52) U.S. Cl. CPC B65F 1/1426; A47L 13/51; B65F 2250/114; B65F 1/16; B65F 1/1473

(57) ABSTRACT

An improved garbage can including a main body including at least one side wall, a front panel member, an open top portion, a top panel member, and a bottom panel member; and at least one wheel member. The at least one side wall forms a front opening adapted to allow garbage bags to pass therethrough. The open top portion is formed by upper edges of said at least one side wall and is adapted to allow garbage bags to pass therethrough. The at least one side wall, the front panel member, the top panel member, and the bottom panel member define an interior volume adapted to removably hold garbage bags therein. A garbage removal kit is also disclosed herein comprising: a plurality of garbage bags; a plurality of cleaning members; and the improved garbage can.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The garbage and trash cans and more specifically relates to an improved garbage can comprising a pair of front-opening access doors that will enable the user to simply slide the heavy trash-bag into or out of the can, rather than lifting or dropping it through the top.

### 2. Description of the Related Art

A waste container is a container for temporarily storing waste, and is usually made out of metal or plastic. Garbage may refer to food waste specifically (when distinguished from “trash”) or to municipal solid waste in general.

Every consumer household across the country—and millions of business, commercial, and institutional establishments—relies upon one or more plastic trash receptacles for the collection of their kitchen refuse. And when the trashcan liner is full, it must be lifted out of the can and carried outside to another receptacle for disposal—where it must be lifted again, and dropped into the receptacle. When the garbage bag is heavy, this can be a real ordeal. What's needed is an easier, less physically demanding way to get the trash-bag out of the indoor receptacle, and into the outdoor one—and that is exactly what the invention to be presented here would provide.

Various attempts have been made to solve problems found in garbage and trash cans art. Among these are found in: U.S. Publication No. 2013/0048641 to Stephen Romano; U.S. Pat. No. 5,901,872 to Tracy L Rudder et al; and U.S. Pat. No. D450,166 to Gerald P. Skalka. This prior art is representative of garbage and trash cans with doors opening on the side useful for removing bags of trash without lifting through a top opening.

Ideally, an improved garbage can should be user-friendly and safe in-use and, yet should operate reliably and be manufactured at a modest expense. Thus, a need exists for an improved garbage can comprising a pair of front-opening access doors that will enable the user to simply slide the heavy trash-bag into or out of the can, rather than lifting or dropping it through the top and to avoid the above-mentioned problems

### BRIEF SUMMARY OF THE INVENTION

In view of the foregoing disadvantages inherent in the known garbage and trash cans art, the present invention provides an Improved Garbage Can. The general purpose of the present invention, which will be described subsequently in greater detail is to provide an improved garbage can comprising a pair of front-opening access doors that will enable the user to simply slide the heavy trash-bag into or out of the can, rather than lifting or dropping it through the top

An improved garbage can comprising: a main body including at least one side wall, a front panel member, an open top portion, a top panel member, and a bottom panel member; and at least one wheel member. The at least one side wall forms a front opening adapted to allow garbage bags to pass therethrough. The front panel member is pivotally attached to one of the at least one side wall and adapted to removably cover the front opening. The open top portion is formed by upper edges of said at least one side wall and is adapted to allow garbage bags to pass therethrough. The top panel member is pivotally attached to one of the at least one side wall and is adapted to removably cover the open top portion. The bottom panel member is attached to lower edges of the at least one side wall. The at least one side wall, the front panel member, the top panel member, and the bottom panel member define an interior volume adapted to removably hold garbage bags therein. The at least one wheel member is rotationally attached to the main body and is adapted to allow the improved garbage can to be moved from one position to another.

A garbage removal kit is also disclosed herein comprising: a plurality of garbage bags; a plurality of cleaning members; and the improved garbage can.

The present invention holds significant improvements and serves as an Improved Garbage Can. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Improved Garbage Can, constructed and operative according to the teachings of the present invention.

FIG. 1 shows a perspective view illustrating an Improved Garbage Can according to an embodiment of the present invention.

FIG. 2 is a left-side perspective view illustrating another view of the Improved Garbage Can according to an embodiment of the present invention of FIG. 1.

FIG. 3 is a right-side perspective view illustrating the Improved Garbage Can according to an embodiment of the present invention of FIG. 1.

FIG. 4 is a back perspective view illustrating the Improved Garbage Can according to an embodiment of the present invention of FIG. 1.

FIG. 5 is a perspective view illustrating a garbage removal kit of the Improved Garbage Can according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to garbage and trash cans and more specifically relates to an improved garbage can comprising a pair of front-opening access doors that will enable the user to simply slide the heavy trash-bag into or out of the can, rather than lifting or dropping it through the top

Generally speaking, the Improved Garbage Can comprises a new design for a product line of indoor and outdoor trash cans—kitchen trash and garbage cans; pull-and-roll outdoor cans—all of which would feature a unique, user-friendly, front-opening pair of doors permitting the can to be loaded, or unloaded, by sliding the trash-bag in or out, rather than lifting it. Thus, the Improved Garbage Can would offer consumers—especially the elderly and less physically robust—a far easier means of removing a full trash-bag from their kitchen (or break-room, garage, etc.), and depositing it in their outside receptacle.

The Improved Garbage Can would feature a unique, user-friendly, front-opening pair of doors permitting the can to be loaded, or unloaded, by sliding the trash-bag in or out, rather than lifting it. Thus, the Improved Garbage Can would offer consumers—especially the elderly and less physically robust—a far easier means of removing a full trash-bag from their kitchen and depositing it in their outside receptacle.

The cans of the Improved Garbage Can line would be fabricated in a tough and durable molded thermoplastic strategically reinforced with aluminum, and the cans would run the gamut between kitchen cans and wheeled outdoor cans. The kitchen cans of the Improved Garbage Can line could be produced in a variety of styles and capacities and with such features as foot-pedal opening, swing-top lids, and so forth. The cans could be produced in a wide range of sizes to meet consumer needs, and a range of colors to suit consumer tastes and decors. The outdoor receptacles would, in most respects, closely resemble other high-capacity rolling cans, with hinged, snap-locking lids, heavy-duty aluminum pull-handles, and rubber wheels on an aluminum axle.

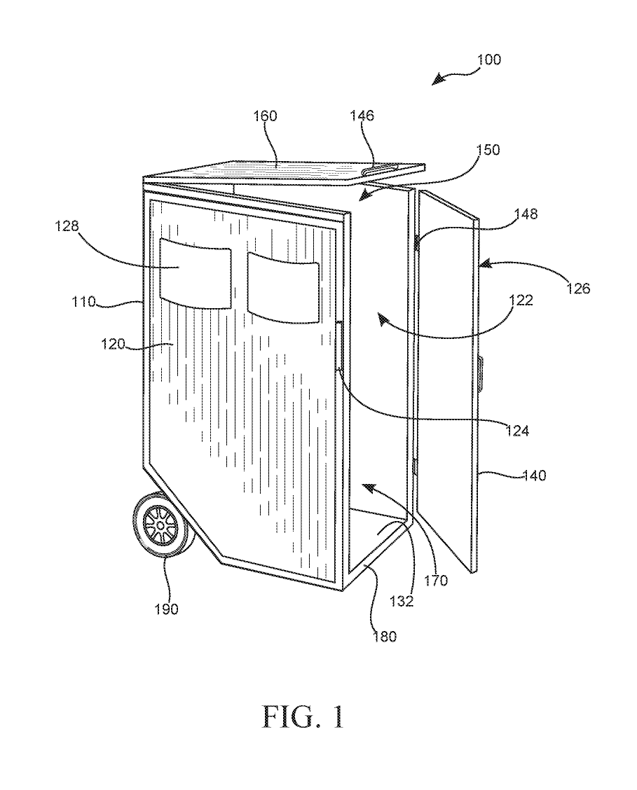

While everyday use of the (indoor) Improved Garbage Can would be identical to that of other indoor trash receptacles, the design distinction comes into play when the full can-liner must be removed for transfer to an outdoor receptacle. At this point, rather than removing the can's lid and hoisting the heavy bag out through the top of the can, one would simply remove the lid, tie the can-liner shut, then open the two front doors and slide the full trash-bag out—a far easier matter to accomplish. And when the full trash-bag is to be deposited in the outdoor Improved Garbage Can, the user would simply open the front doors on that receptacle, and slide the full bag into the can. Again, there's no lifting involved on the part of the consumer. The Improved Garbage Can is cost-effective to produce in the embodiments, as shown in FIG. 1.

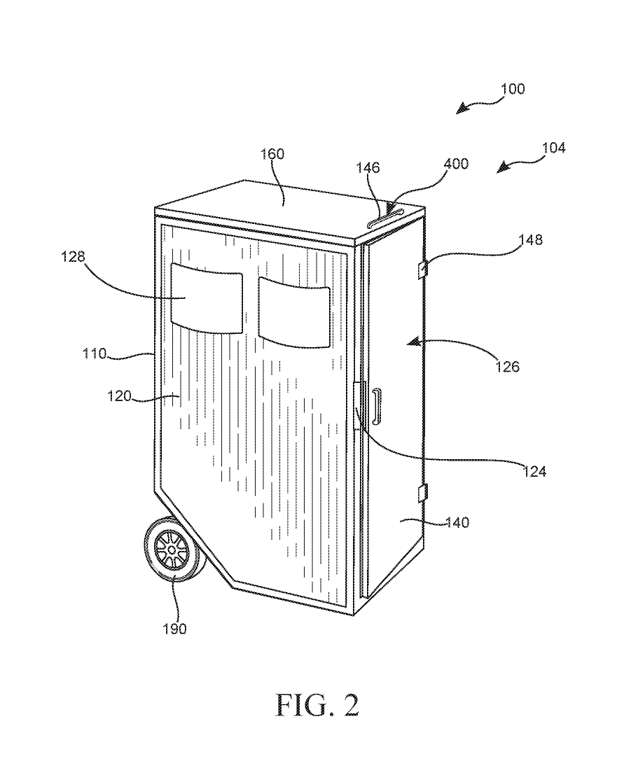

Referring now to FIGS. 1-4, showing perspective views illustrating improved garbage can 100 according to an embodiment of the present invention of FIG. 1.

Improved garbage can 100 comprising: main body 110 including at least one side wall 120, front panel member 140, open top portion 150, top panel member 160, and bottom panel member 180; and at least one wheel member 190. At least one side wall 120 forms front opening 122 adapted to allow garbage bags 510 to pass therethrough. Front panel member 140 is pivotally attached to one of at least one side wall 120 and adapted to removably cover front opening 122. Open top portion 150 is formed by upper edges of at least one side wall 120 and is adapted to allow garbage bags 510 to pass therethrough. Top panel member 160 is pivotally attached to one of at least one side wall 120 and is adapted to removably cover open top portion 150. Bottom panel member 180 is attached to lower edges of at least one side wall 120. At least one side wall 120, front panel member 140, top panel member 160, and bottom panel member 180 define interior volume 170 adapted to removably hold garbage bag 510 therein. At least one wheel member 190 is rotationally attached to main body 110 and is adapted to allow improved garbage can 100 to be moved from one position to another. Wherein there are two of at least one wheel member 190 connected to one another via axle member 194; and wherein axle member 194 is attached to main body 110.

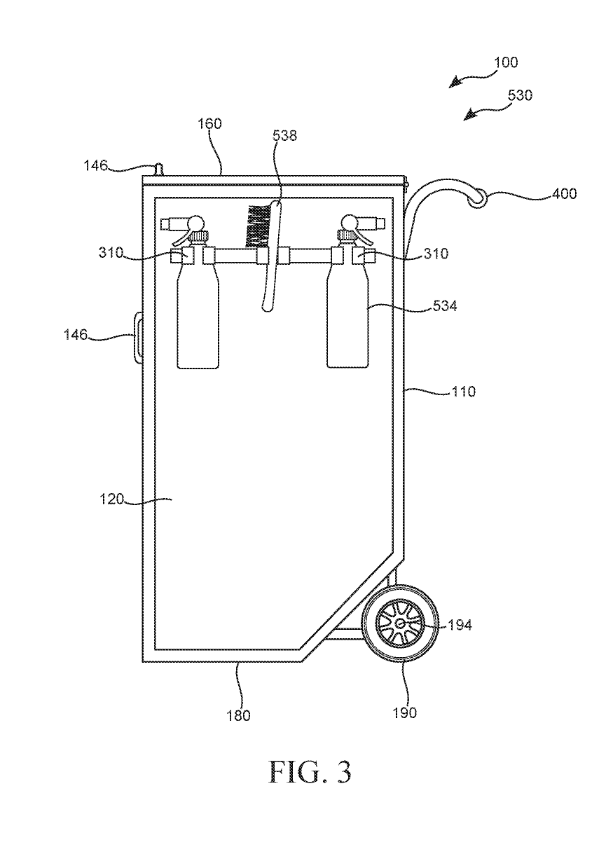

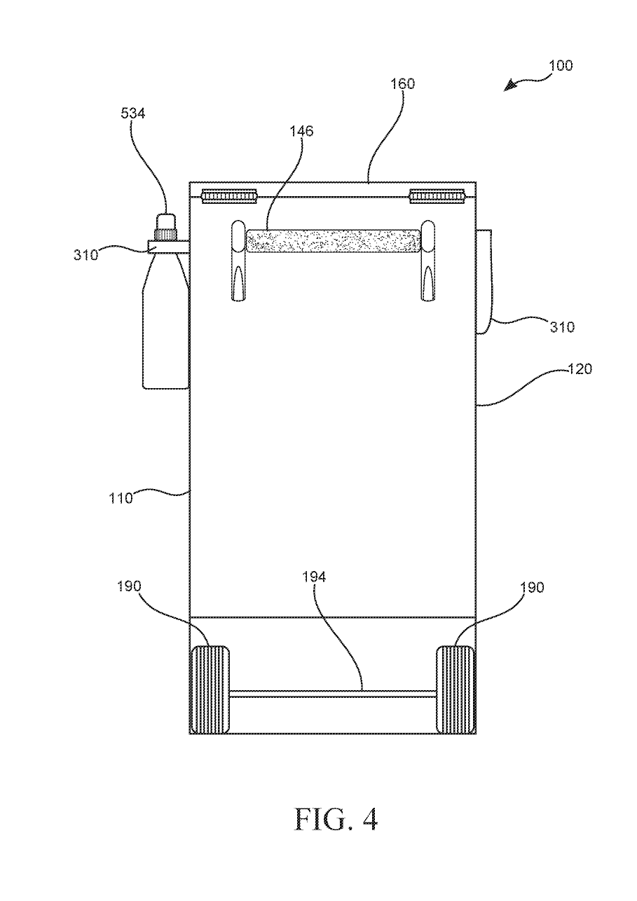

At least one side wall 120 has outer surface 126 and inner surface 132; wherein outer surface 126 of one of at least one side wall 120 includes at least one clip member 310 thereon adapted to releasable hold cleaning members 530 thereon for use in cleaning improved garbage 100 can after use as shown in FIG. 3. At least one side wall 120 has outer surface 126 and inner surface 132; wherein outer surface 126 of one of at least one side wall 120 includes at least one pocket member 128 thereon adapted to releasable hold cleaning members 530 therein for use in cleaning improved garbage can 100 after use. At least one side wall 120 has outer surface 126 and inner surface 132; wherein outer surface 126 of one of at least one side wall 120 includes handle member 400 attached to outer surface 126 as shown in FIG. 4.

Front panel member 140 includes handle member 146 attached to outer surface 126 thereof, and first connector member 148 on a side edge portion thereof; and wherein one of at least one side wall 120 includes second connector member 124 on side edge portion 120 thereof adjacent front opening 122 and adapted to releasably connect with first connector member 148 of front panel member 140, to thereby securely and releasably hold front panel member 140 in closed position 104 of FIG. 1.

Top panel member 160 includes handle member 162 attached to outer surface 126 thereof. Top panel member 160 includes first connector member 164 on an edge portion thereof; and wherein one of at least one side wall 120 includes second connector member 124 on an upper edge portion thereof adapted to releasably connect with first connector member 164 of top panel member 160, to thereby securely and releasably hold top panel member 160 in closed position 104 as shown in FIG. 1.

At least one side wall 120, front panel member 140, top panel member 160, and bottom panel member 180 are formed from molded thermoplastic material. The molded thermoplastic material of at least one side wall 120, front panel member 140, top panel member 160, and bottom panel member 180 includes aluminum mesh infused therein in predetermined locations in order to strengthen improved garbage can 100.

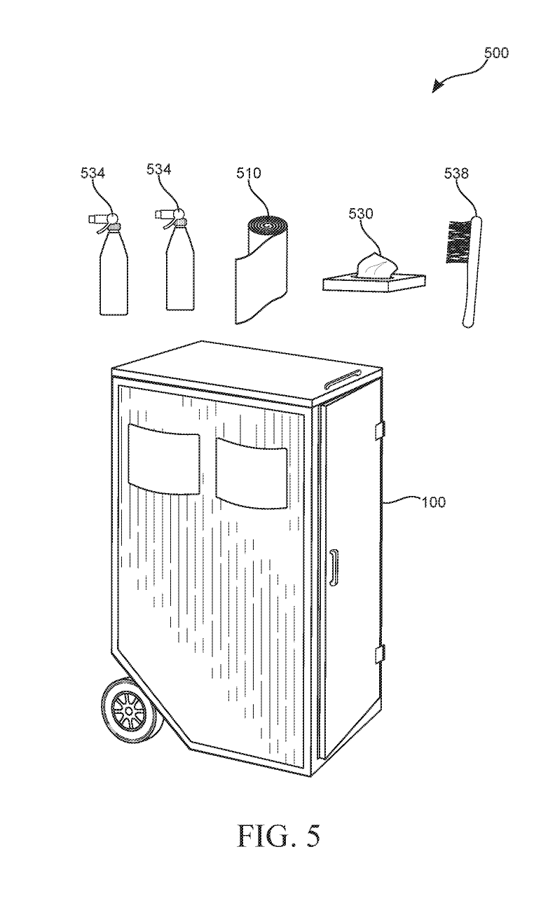

Referring now to FIG. 5 showing a perspective view illustrating garbage removal kit 500 of Improved Garbage Can 100 according to an embodiment of the present invention of FIG. 1.

Garbage removal kit 500 is also disclosed herein comprising: plurality of garbage bags 510; plurality of cleaning members 530; and improved garbage can 500. Plurality of cleaning members 530 are chosen from a group of cleaning members 530 consisting of spray bottles 534 and brush members 538.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An improved garbage can comprising:
a main body including:
at least one side wall;
wherein said at least one side wall forms a front opening adapted to allow garbage bags to pass therethrough;
a front panel member;
wherein said front panel member is pivotally attached to one of said at least one side wall and adapted to removably cover said front opening;
an open top portion;
wherein said open top portion is formed by upper edges of said at least one side wall and is adapted to allow garbage bags to pass therethrough;
a top panel member;
wherein said top panel member is pivotally attached to one of said at least one side wall and is adapted to removably cover said open top portion; and
a bottom panel member;
wherein said bottom panel member is attached to lower edges of said at least one side wall;
wherein said at least one side wall, said front panel member, said top panel member, and said bottom panel member define an interior volume adapted to removably hold garbage bags therein; and at least one wheel member;
wherein said at least one wheel member is rotationally attached to said main body and is adapted to allow said improved garbage can to be moved from one position to another.

2. The improved garbage can of claim 1, wherein said at least one side wall has an outer surface and an inner surface; wherein said outer surface of one of said at least one side wall includes at least one clip member thereon adapted to releasable hold cleaning members thereon for use in cleaning said improved garbage can after use.

3. The improved garbage can of claim 1, wherein said at least one side wall has an outer surface and an inner surface; wherein said outer surface of one of said at least one side wall includes at least one pocket member thereon adapted to releasable hold cleaning members therein for use in cleaning said improved garbage can after use.

4. The improved garbage can of claim 1, wherein said at least one side wall has an outer surface and an inner surface; wherein said outer surface of one of said at least one side wall includes a handle member attached to said outer surface.

5. The improved garbage can of claim 1, wherein said top panel member includes a handle member attached to an outer surface thereof.

6. The improved garbage can of claim 1, wherein said front panel member includes a handle member attached to an outer surface thereof, and a first connector member on a side edge portion thereof; and wherein one of said at least one side wall includes a second connector member on a side edge portion thereof adjacent said front opening and adapted to releasably connect with said first connector member of said front panel member, to thereby securely and releasably hold said front panel member in a closed position.

7. The improved garbage can of claim 5, wherein said top panel member includes a first connector member on an edge portion thereof; and wherein one of said at least one side wall includes a second connector member on an upper edge portion thereof adapted to releasably connect with said first connector member of said top panel member, to thereby securely and releasably hold said top panel member in a closed position.

8. The improved garbage can of claim 1, wherein said at least one side wall, said front panel member, said top panel member, and said bottom panel member are formed from molded thermoplastic material.

9. The improved garbage can of claim 8, wherein said molded thermoplastic material of said at least one side wall, said front panel member, said top panel member, and said bottom panel member includes aluminum mesh infused therein in predetermined locations in order to strengthen said improved garbage can.

10. The improved garbage can of claim 1, wherein there are two of said at least one wheel member connected to one another via an axle member; and wherein said axle member is attached to said main body.

11. A garbage removal kit comprising:
a plurality of garbage bags;
a plurality of cleaning members; and an improved garbage can comprising:
a main body including:
at least one side wall;
wherein said at least one side wall forms a front opening adapted to allow garbage bags to pass therethrough; and
wherein said at least one side wall has an outer surface and an inner surface; wherein said outer surface of one of said at least one side wall includes at least one clip member thereon adapted to releasable hold cleaning members thereon for use in cleaning said improved garbage can after use;
a front panel member;
wherein said front panel member is pivotally attached to one of said at least one side wall and adapted to removably cover said front opening;
an open top portion;
wherein said open top portion is formed by upper edges of said at least one side wall and is adapted to allow garbage bags to pass therethrough;
a top panel member;
wherein said top panel member is pivotally attached to one of said at least one side wall and is adapted to removably cover said open top portion; and
a bottom panel member;
wherein said bottom panel member is attached to lower edges of said at least one side wall;
wherein said at least one side wall, said front panel member, said top panel member, and said bottom panel member define an interior volume adapted to removably hold garbage bags therein; at least one wheel member;
wherein said at least one wheel member is rotationally attached to said main body and is adapted to allow said improved garbage can to be moved from one position to another;
wherein each of said plurality of garbage bags are adapted to be filled with garbage, sealed, and placed within said improved garbage can for disposal; and
wherein each of said plurality of cleaning members are adapted to releasably clipped onto a respective one of said at least one clip member and adapted to be used in cleaning said improved garbage can after use.

12. The garbage removal kit of claim 11, wherein said at least one side wall has an outer surface and an inner surface; wherein said outer surface of one of said at least one side wall includes at least one pocket member thereon adapted to releasable hold additional cleaning members therein for use in cleaning said improved garbage can after use.

13. The garbage removal kit of claim 11, wherein said at least one side wall has an outer surface and an inner surface; wherein said outer surface of one of said at least one side wall includes a handle member attached to said outer surface.

14. The garbage removal kit of claim 11, wherein said top panel member includes a handle member attached to an outer surface thereof.

15. The garbage removal kit of claim 11, wherein said front panel member includes a handle member attached to an outer surface thereof, and a first connector member on a side edge portion thereof; and wherein one of said at least one side wall includes a second connector member on a side edge portion thereof adjacent said front opening and adapted to releasably connect with said first connector member of said front panel member, to thereby securely and releasably hold said front panel member in a closed position.

16. The garbage removal kit of claim 14, wherein said top panel member includes a first connector member on an edge portion thereof; and wherein one of said at least one side wall includes a second connector member on an upper edge portion thereof adapted to releasably connect with said first connector member of said top panel member, to thereby securely and releasably hold said top panel member in a closed position.

17. The garbage removal kit of claim 11, wherein said at least one side wall, said front panel member, said top panel member, and said bottom panel member are formed from molded thermoplastic material.

18. The garbage removal kit of claim 17, wherein said molded thermoplastic material of said at least one side wall, said front panel member, said top panel member, and said bottom panel member includes aluminum mesh infused therein in predetermined locations in order to strengthen said improved garbage can.

19. The garbage removal kit of claim 11, wherein there are two of said at least one wheel member connected to one another via an axle member; and wherein said axle member is attached to said main body.

20. The garbage removal kit of claim 11, wherein said plurality of cleaning members are chosen from a group of cleaning members consisting of spray bottles and brush members.
